(19) United States
(12) Patent Application Publication
(10) Pub. No.: US 2014/0023927 A1
(43) Pub. Date: Jan. 23, 2014

(54) SILICON ALLOY BASED NEGATIVE ACTIVE MATERIAL AND COMPOSITION INCLUDING SAME AND METHOD OF PREPARING SAME AND LITHIUM RECHARGEABLE BATTERY

(71) Applicants: Yo-Han PARK, Yongin-si (KR); Chun-Gyoo LEE, Yongin-si (KR); Sung-Hwan MOON, Yongin-si (KR); Jae-Hyuk KIM, Yongin-si (KR); Seung-Uk KWON, Yongin-si (KR); Yury MATULEVICH, Yongin-si (KR); Chang-Ui JEONG, Yongin-si (KR); Jong-Seo CHOI, Yongin-si (KR)

(72) Inventors: Yo-Han PARK, Yongin-si (KR); Chun-Gyoo LEE, Yongin-si (KR); Sung-Hwan MOON, Yongin-si (KR); Jae-Hyuk KIM, Yongin-si (KR); Seung-Uk KWON, Yongin-si (KR); Yury MATULEVICH, Yongin-si (KR); Chang-Ui JEONG, Yongin-si (KR); Jong-Seo CHOI, Yongin-si (KR)

(21) Appl. No.: 13/746,648

(22) Filed: Jan. 22, 2013

(30) Foreign Application Priority Data
Jul. 20, 2012 (KR) 10-2012-0079421

(51) Int. Cl. H01M 4/134

(52) U.S. Cl. CPC H01M 4/134
USPC 429/217; 427/58

(57) ABSTRACT

A silicon alloy-based negative active material includes a particle including a core including a silicon alloy-based material, and a coating layer including an organic binder.

### CROSS-REFERENCE TO RELATED APPLICATION

This application claims priority under 35 U.S.C. §119 to Korean Patent Application No. 10-2012-0079421 filed in the Korean Intellectual Property Office on Jul. 20, 2012, and entitled “SILICON ALLOY BASED NEGATIVE ACTIVE MATERIAL AND COMPOSITION INCLUDING SAME AND METHOD OF PREPARING SAME AND LITHIUM RECHARGEABLE BATTERY,” the entire contents of which is incorporated herein by reference.

### BACKGROUND

Embodiments relate to a silicon alloy-based negative active material, a negative active material composition including the same, and a method of preparing the same, and a lithium rechargeable battery including the same.

### SUMMARY

Embodiments are directed to a silicon alloy-based negative active material, including a particle including a core including a silicon alloy-based material, and a coating layer including an organic binder.

The organic binder may include polyimide, polyamide, polyamideimide, aramid, polyarylate, polymethylethylketone, polyetherimide, polyethersulfone, polysulfone, polyphenylene sulfide, polytetrafluoroethylene, or a combination thereof.

The organic binder may be included in an amount of about 1 wt % to about 10 wt % based on 100 wt % of the silicon alloy-based negative active material.

The silicon alloy-based material may be an alloy represented by Si-Q, wherein

Q is not Si and is an alkali metal, an alkaline-earth metal, a group 13 to 16 elements, a transition element, a rare earth element, or a combination thereof.

The silicon alloy-based material may be SiTiNi, SiAlMn, SiAlFe, SiFeCu, SiCuMn, SiMgAl, SiMgCu, or a combination thereof.

The organic binder may include polyamideimide, polyetherimide, or a combination thereof, and the silicon alloy-based material may be SiTiNi.

The silicon alloy-based material may be included in an amount of about 50 wt % to about 99 wt % based on 100 wt % of the silicon alloy-based negative active material.

The coating layer may have an average thickness of about 1 nm to about 300 nm.

The coating layer may have a first portion with a thickness of about 1 nm to about 35 nm.

The coating layer may have a second portion with a thickness of about 100 nm to about 300 nm.

The coating layer may be continuous.

The coating layer may be discontinuous.

The core may have an average diameter ranging from about 0.1 μm to about 10 μm.

Embodiments are also directed to a negative active material composition, including the silicon alloy-based negative active material, and a binder.

Embodiments are also directed to a method of manufacturing a negative active material composition, including preparing a silicon alloy-based material, and coating an organic binder on a surface of the silicon alloy-based material to form a coated silicon alloy-based negative active material.

The method may further include mixing the coated silicon alloy-based negative active material and a binder.

The coating of the organic binder may include drying at about 100° C. to about 120° C.

The coating of the organic binder may include heat treatment at about 300° C. to about 400° C.

The organic binder may include polyamideimide, polyetherimide, or a combination thereof, and the silicon alloy-based material may be SiTiNi.

Embodiments are also directed to a lithium rechargeable battery, including a negative electrode including the silicon alloy-based negative active material, a positive electrode including a positive active material, and a non-aqueous electrolyte.

### BRIEF DESCRIPTION OF THE DRAWINGS

Features will become apparent to those of skill in the art by describing in detail exemplary embodiments with reference to the attached drawings in which:

FIG. 1 illustrates a schematic view a lithium rechargeable battery according to an embodiment.

FIGS. 2 to 12 illustrate TEM images of various regions of a silicon alloy-based negative active material according to Example 1.

FIGS. 13 to 24 illustrate TEM images of various regions of a silicon alloy-based negative active material according to Example 2.

FIG. 25 illustrates a TEM image of a silicon alloy SiTiNi negative active material according to Comparative Example 1.

FIGS. 26 and 27 illustrate graphs of ATR-FTIR analysis results of the negative active materials according to Examples 1 and 2.

FIG. 28 illustrates a graph of discharge capacity depending on cycles of lithium rechargeable battery cells according to Examples 3 and 4 and Comparative Example 2.

FIG. 29 illustrates a graph of capacity retention depending on cycles of lithium rechargeable battery cells according to Examples 3 and 4 and Comparative Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The silicon alloy-based negative active material according to an embodiment may include a particle including a core including a silicon alloy-based material, and a coating layer including an organic binder.

The organic binder included in the coating layer may adhere the particles together (i.e., adhere the particles to themselves) and also, may adhere the silicon alloy-based negative active material to a current collector.

The organic binder may include, for example, polyimide, polyamide, polyamideimide, aramid, polyarylate, polymethylethylketone, polyetherimide, polyethersulfone, polysulfone, polyphenylene sulfide, polytetrafluoroethylene, and the like, and a combination thereof. The organic binder may be a material having excellent mechanical, thermal, and chemical stability, and thus may effectively suppress volume expansion of the silicon alloy-based material. For example, the organic binder may be selected from polyetherimide, polyamideimide, and a combination thereof.

The organic binder may be included in an amount of about 1 wt % to about 10 wt % based on 100 wt % of the silicon alloy-based negative active material, and thus the silicon alloy-based material may maintain an appropriate volume and may secure improved capacity and cycle-life characteristics.

The silicon alloy-based material may be represented by a Si-Q alloy wherein the Q may be, e.g., an alkali metal, an alkaline-earth metal, a Group 13 to 16 elements, a transition element, a rare earth element, or a combination thereof, but not Si. Q may be, e.g., Ni, Mn, Mg, Ca, Sr, Ba, Ra, Sc, Y, Ti, Zr, Hf, Rf, V, Nb, Ta, Db, Cr, Mo, W, Sg, Mn, Tc, Re, Bh, Fe, Pb, Ru, Os, Hs, Rh, Ir, Ni, Pd, Pt, Cu, Ag, Au, Zn, Cd, B, Al, Ga, Sn, In, Ti, Ge, P, As, Sb, Bi, S, Se, Te, Po, or a combination thereof.

In an embodiment, the silicon alloy-based material may be selected from SiTiNi, SiAlMn, SiAlFe, SiFeCu, SiCuMn, SiMgAl, SiMgCu, or a combination thereof.

The silicon alloy-based material may be included in an amount of about 50 wt % to about 100 wt % based on 100 wt % of the silicon alloy-based negative active material, and thus improved capacity and cycle-life characteristics may be secured.

According to an embodiment, the silicon alloy-based negative active material may have particles formed by coating the organic binder material on the surface of the silicon alloy-based material. The coating layer including the organic binder may be continuous or discontinuous (i.e., incontinuous). In other words, the coating layer may be formed partially or completely over the particles.

The coating layer may be about 1 nm to about 300 nm thick, e.g., about 50 nm to about 150 nm thick. The coating layer may have a thickness related to the amount of the organic binder. Accordingly, when the coating layer has a thickness within this range, the silicon alloy-based negative active material may include the organic binder and the silicon alloy-based material in an appropriate ratio, and thus may secure improved capacity and cycle-life characteristics of a lithium rechargeable battery. The coating layer may be continuous and may have a first portion having a first thickness and a second portion having a second thickness different from the first thickness. The first portion of the coating layer may be about 1 nm to about 35 nm thick, e.g., about 1 nm to about 10 nm thick, and the second portion of the coating layer may be about 100 nm to about 300 nm thick, e.g., about 100 nm to about 150 nm thick.

The core may have an average diameter ranging from about 0.1 μm to about 10 μm, e.g., about 3 μm to about 7 μm. The core may have a particle size related to the amount of the silicon alloy-based material and also related to the entire particle size of the silicon alloy-based material. Accordingly, when the core is formed to have a size within this range, the silicon alloy-based negative active material may include the organic binder and the silicon alloy-based material in an appropriate ratio, and thus may secure improved capacity and cycle-life characteristics of a lithium rechargeable battery.

According to an embodiment, a negative active material composition may include the silicon alloy-based negative active material.

The negative active material composition may include the silicon alloy-based negative active material, a binder, and optionally a conductive material.

The silicon alloy-based negative active material may be the same as described above.

The binder may improve binding properties of the silicon alloy-based negative active materials to one another and/or to a current collector. Examples of the binder may include polyamideimide, polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may provide an electrode with conductivity. A suitable electrically conductive material may be used as the conductive material, unless it causes an undesirable chemical change. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

According to an embodiment, a method of preparing a negative active material composition may include preparing a silicon alloy-based material, coating an organic binder on the surface of the silicon alloy-based material, and mixing the coated silicon alloy-based negative active material with a binder.

The silicon alloy-based material may be prepared by, for example, melting silicon and a metal, mixing the melted product using a melt spinner, and solidifying the melted mixture alloy. The silicon alloy-based material may include, for example, one selected from SiTiNi, SiAlMn, SiAlFe, SiFeCu, SiCuMn, SiMgAl, SiMgCu, and a combination thereof.

Next, the silicon alloy-based material may be mixed with an organic binder.

The organic binder may be, for example, polyimide, polyamide, polyamideimide, aramid, polyarylate, polymethylethylketone, polyetherimide, polyethersulfone, polysulfone, polyphenylene sulfide, polytetrafluoroethylene, or a combination thereof, and may be included, for example, in the form of a powder. Then, the mixture may be dried and heat-treated at a predetermined temperature to coat the organic binder on the surface of the silicon alloy-based material. The drying may be performed, for example, at about 100° C. to about 150° C., for example, for about 10 minutes to about 6 hours. The drying step may be performed under the vacuum condition. The heat treatment at the predetermined temperature may be performed, for example, at about 300° C. to about 400° C., for example, for about 1 hour to about 2 hours. The heat treatment may be omitted.

According to the above method, a silicon alloy-based material may form a core, and the organic binder may be continuously or discontinuously coated on the surface of the core.

Thereafter, the coated silicon alloy-based negative active material is mixed with the binder. The binder improves binding properties of negative active material particles with one another and with a current collector. The binder includes a non-water-soluble binder, a water-soluble binder, or a combination thereof.

The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The alkali metal may be Na, K, or Li. The cellulose-based compound may be included in an amount of about 0.1 to about 3 parts by weight based on 100 parts by weight of the negative active material.

During the mixing, the conductive material may be further added.

According to an embodiment, a lithium rechargeable battery may include a negative electrode including the silicon alloy-based negative active material, a positive electrode including a positive active material being capable of intercalating and deintercalating lithium, and a non-aqueous electrolyte.

The lithium rechargeable battery may be, e.g., a lithium ion battery, a lithium ion polymer battery, and a lithium polymer battery according to the presence of a separator and the kind of electrolyte used in the battery. The rechargeable lithium battery may have a variety of shapes and sizes, and may include, e.g., cylindrical, prismatic, or coin-type batteries, and may be a thin film battery or a relatively bulky type battery. Structures and fabrication methods for the battery may be suitable structures and fabrication methods.

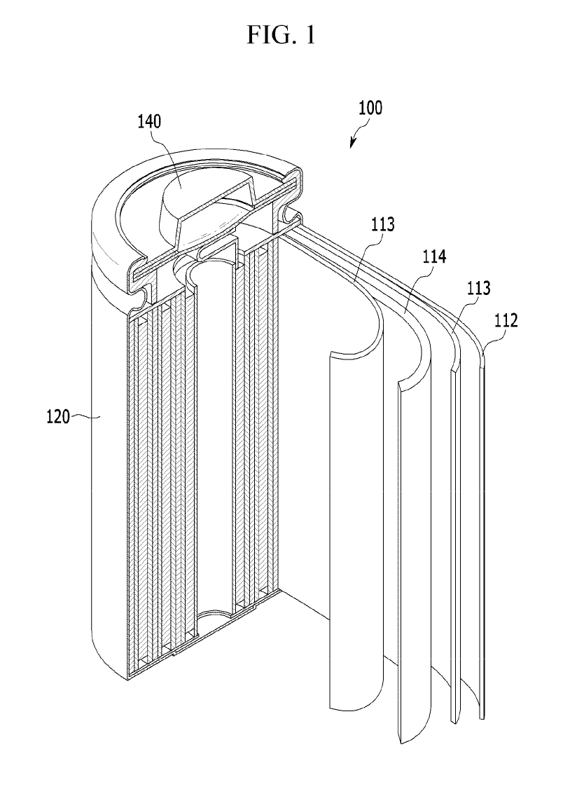

FIG. 1 illustrates an exploded perspective view of an exemplary lithium rechargeable battery in accordance with an embodiment. Referring to FIG. 1, the lithium rechargeable battery 100 may be formed to have a cylindrical shape and may include a negative electrode 112, a positive electrode 114, a separator 113 disposed between the negative and positive electrodes 112 and 114, an electrolyte (not shown) impregnated in the negative and positive electrodes 112 and 114 and the separator 113, a battery case 120, and a sealing member 140 sealing the battery case 120. Such a lithium rechargeable battery 100 may be fabricated by sequentially stacking the negative electrode 112, separator 113, and positive electrode 114, spiral-winding them, and housing the wound product in the battery case 120.

The negative electrode may include a current collector and a negative active material layer formed over the current collector, and the negative active material layer may include the silicon alloy-based negative active material coated with the organic binder, a binder, and optionally a conductive material.

The silicon alloy-based negative active material, binder, and conductive material may be the same as described above.

The current collector may be a copper foil, a nickel foil, a stainless steel foil, a titanium foil, a nickel foam, a copper foam, a polymer substrate coated with a conductive metal, and the like, or a combination thereof.

The positive electrode may include a current collector and a positive active material layer disposed on the current collector.

The positive active material may include a lithiated intercalation compound that reversibly intercalates and deintercalates lithium ions. The positive active material may include, e.g., a composite oxide including at least one selected from the group of cobalt, manganese, and nickel, as well as lithium. In particular, the following lithium-containing compounds may be used:

LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5, and 0≦c≦0.05); LiE_{2-b}R_{b}O_{4-c}D_{c} (0≦b≦0.5 and 0≦c≦0.05); LiₐNi_{1-b-c}Co_{b}R_{c}D_{α} (0.90≦a≦1.8, 0≦b≦0.5, 0≦c≦0.05, and 0<α≦2); LiₐNi_{1-b-c}Co_{b}R_{c}O_{2-α}Z_{α} (0.90≦a≦1.8, 0≦b≦0.5, 0≦c≦0.05, and 0<α<2); LiₐNi_{1-b-c}Co_{b}R_{c}O_{2-α}Z₂ (0.90≦a≦1.8, 0≦b≦0.5, 0≦c≦0.05, and 0<α<2); LiₐNi_{1-b-c}Mn_{b}R_{c}D_{α} (0.90≦a≦1.8, 0≦b≦0.5, 0≦c≦0.05, and 0<α≦2); LiₐNi_{1-b-c}Mn_{b}R_{c}O_{2-α}Z_{α} (0.90≦a≦1.8, 0≦b≦0.5, 0≦c≦0.05, and 0<α<2); LiₐNi_{1-b-c}Mn_{b}R_{c}O_{2-α}Z₂ (0.90≦a≦1.8, 0≦b≦0.5, 0<c≦0.05, and 0<α<2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GeO₂ (0.90≦a≦1.8, 0≦b≦0.9, 0≦c≦0.5, 0≦d≦0.5, and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A may be Ni, Co, Mn, or a combination thereof; R may be Al, Ni, Co, Mn, Cr, Fe, Mg, Sr, V, a rare earth element, or a combination thereof; D may be O, F, S, P, or a combination thereof; E may be Co, Mn, or a combination thereof; Z may be F, S, P, or a combination thereof; G may be Al, Cr, Mn, Fe, Mg, La, Ce, Sr, V, or a combination thereof; Q may be Ti, Mo, Mn, or a combination thereof; T may be Cr, V, Fe, Sc, Y, or a combination thereof; and J may be V, Cr, Mn, Co, Ni, Cu, or a combination thereof.

The lithiated intercalation compound may have a coating layer on the surface or may be mixed with a compound having a coating layer. The coating layer may include at least one coating element compound selected from the group of an oxide of a coating element, a hydroxide of a coating element, an oxyhydroxide of a coating element, an oxycarbonate of a coating element, and a hydroxyl carbonate of a coating element. The compounds for a coating layer may be amorphous or crystalline. The coating element for a coating layer may include Mg, Al, Co, K, Na, Ca, Si, Ti, V, Sn, Ge, Ga, B, As, Zr, or a mixture thereof. When these elements are included in the compound for a coating layer, the coating layer may be formed in a suitable method without any substantial negative influence on the properties of the positive active material. For example, the method may include, e.g., spray coating, dipping, and the like.

The positive active material layer may include a binder and a conductive material.

The binder may improve binding properties of the positive active material particles to one another and/or to a current collector. Examples of the binder may include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may be used to provide conductivity to an electrode. In the lithium rechargeable battery, the conductive material may include a suitable electronic conductive material, unless it causes an undesirable chemical change. Examples of the conductive material may be at least one of a conductive material such as natural graphite, artificial graphite, carbon black, acetylene black, ketjen black, a carbon fiber, a metal powder, a metal fiber or the like such as copper, nickel, aluminum, silver or the like, or a polyphenylene derivative or the like, and mixtures thereof.

The current collector may be, for example, Al or the like.

The negative and positive electrodes may be fabricated in a method including mixing the respective active materials, a binder, optionally a conductive material, and a solvent to prepare an active material composition and coating the composition on a current collector, respectively. The solvent may include, e.g., N-methylpyrrolidone and the like.

The electrolyte may include a non-aqueous organic solvent and a lithium salt.

The non-aqueous organic solvent may serve as a medium for transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and the like. Examples of the ether-based solvent may include dibutyl ether, tetraglyme, diglyme, dimethoxyethane, 2-methyltetrahydrofuran, tetrahydrofuran, and examples of the ketone-based solvent may include cyclohexanone, and the like. Examples of the alcohol-based solvent may include ethyl alcohol, isopropyl alcohol, and the like, and examples of the aprotic solvent may include nitriles such as R—CN (wherein R may be a C2 to C20 linear, branched, or cyclic hydrocarbon group including a double bond, an aromatic ring, or an ether bond), amides such as dimethylformamide, dioxolanes such as 1,3-dioxolane, sulfolanes, or the like.

The non-aqueous organic solvent may be used singularly or in a mixture. When the organic solvent is used in a mixture, the mixing ratio may be controlled in accordance with a desirable battery performance.

The carbonate-based solvent may be prepared by mixing a cyclic carbonate and a linear carbonate. The cyclic carbonate and the linear carbonate may be mixed together in a volume ratio of about 1:1 to about 1:9. Within this range, performance of electrolyte may be improved.

The non-aqueous organic electrolyte may be further prepared by mixing a carbonate-based solvent with an aromatic hydrocarbon-based solvent. The carbonate-based and the aromatic hydrocarbon-based solvents may be mixed together in a volume ratio ranging from about 1:1 to about 30:1.

The aromatic hydrocarbon-based organic solvent may be represented by the following Chemical Formula 1.

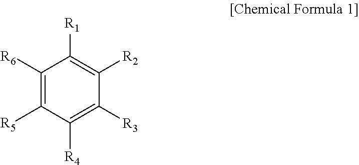

In Chemical Formula 1, R₁ to R₆ are each independently hydrogen, a halogen, a C1 to C10 alkyl group, a C1 to C10 haloalkyl group, or a combination thereof.

The aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate, an ethylene carbonate-based compound represented by the following Chemical Formula 2, or a combination thereof as an additive, and thus cycle-life may be improved.

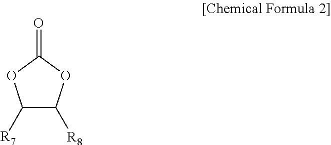

In Chemical Formula 2, R₇ and R₈ may be independently selected from hydrogen, halogen, a cyano group (CN), a nitro group (NO₂), and a C1 to C5 fluoroalkyl group, provided that at least one of R₇ and R₈ is selected from halogen, a cyano group (CN), a nitro group (NO₂), and a C1 to C5 fluoroalkyl group.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound may be adjusted within an appropriate range, and thus cycle-life may be improved.

The lithium salt may be dissolved in an organic solvent, and may supply lithium ions in the battery to provide for the basic operation of the rechargeable lithium battery, and thus may improves lithium ion transportation between positive and negative electrodes therein. Examples of the lithium salt may include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers), LiCl, LiI, LiB(C₂O₄)₂ (lithium bis(oxalato) borate, LiBOB), or a combination thereof, as a supporting electrolytic salt. The lithium salt may be used in a concentration ranging from about 0.1 M to about 2.0 M, and thus an electrolyte may have improved performance and lithium ion mobility due to improved electrolyte conductivity and viscosity.

The separator 113 may include a suitable material that separated a negative electrode 112 from a positive electrode 114, and provides a transporting passage for lithium ions. In other words, it may have a low resistance against ion transportation and an excellent impregnation for an electrolyte. For example, it may be selected from glass fiber, polyester, TEFLON (tetrafluoroethylene), polyethylene, polypropylene, polytetrafluoroethylene (PTFE), or a combination thereof. It may have a form of a non-woven fabric or a woven fabric. For example, as for a lithium ion battery, a polyolefin-based polymer separator such as polyethylene, polypropylene or the like may be used. A coated separator may include a ceramic component or a polymer material may be used, and thus heat resistance and/or mechanical strength of the lithium ion battery may be improved. The separator may have a mono-layered or multi-layered structure.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### Preparing a Negative Active Material

A SiTiNi powder having an average diameter of about 5 μm was prepared using a melt spinning equipment. A PEI powder (polyetherimide, 700193, Sigma Aldrich Co., Ltd.) was mixed in N-methylpyrrolidone, and the mixture was agitated at 50° C. for 24 hours. Next, the SiTiNi powder was added thereto, and the resulting mixture was agitated at room temperature for 24 hours, filtered, and vacuum-dried at 120° C. for 6 hours, to prepare a negative active material.

The prepared negative active material had a core having an average diameter of about 5 μm and a coating layer having an average thickness of 50 nm, and the SiTiNi and PEI were mixed in a weight ratio of 95:5. The coating layer was continuous.

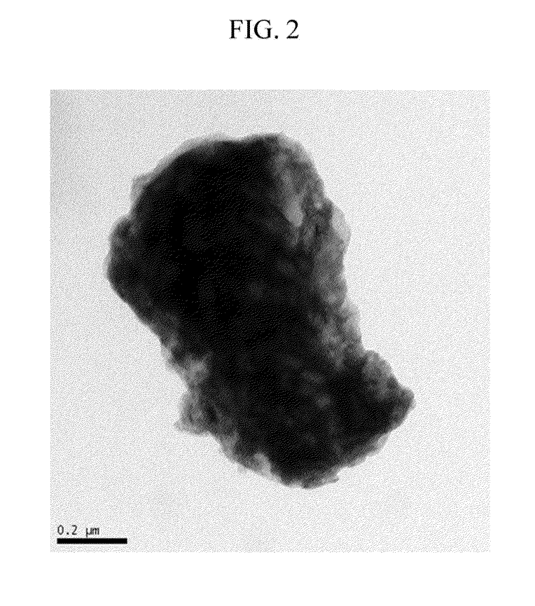

FIGS. 2 to 13 illustrate TEM images of the negative active material particles according to Example 1 to examine thickness of the coating layers thereon.

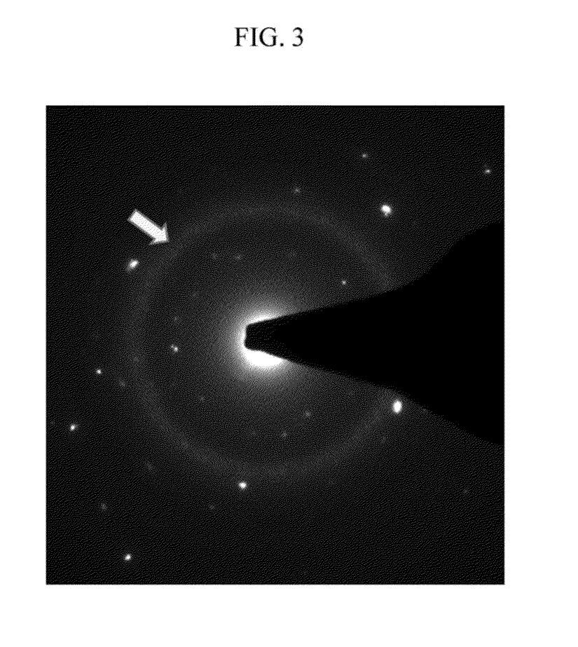

In FIG. 3, the thick ring near the arrow shows that the organic binder of PEI was coated on SiTiNi powder and formed a coating layer.

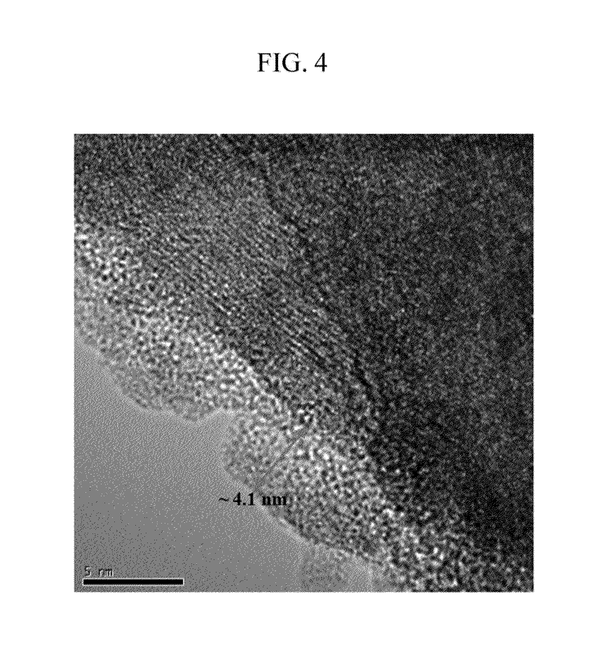

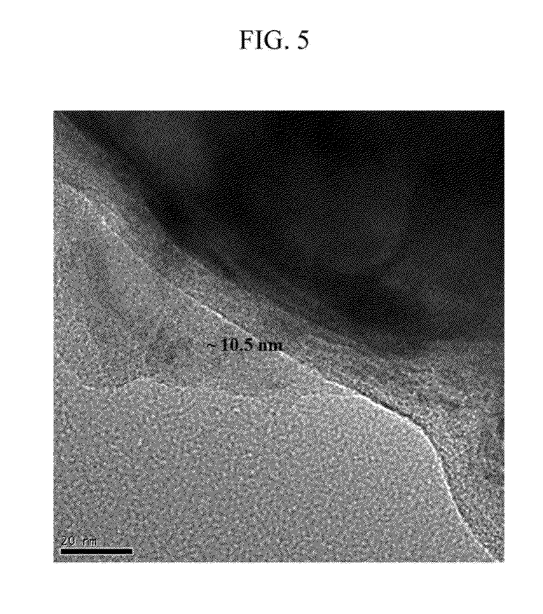

In FIGS. 4 and 5, the organic binder of PEI was coated and formed to be respectively about 4.1 nm and 10.5 nm thick.

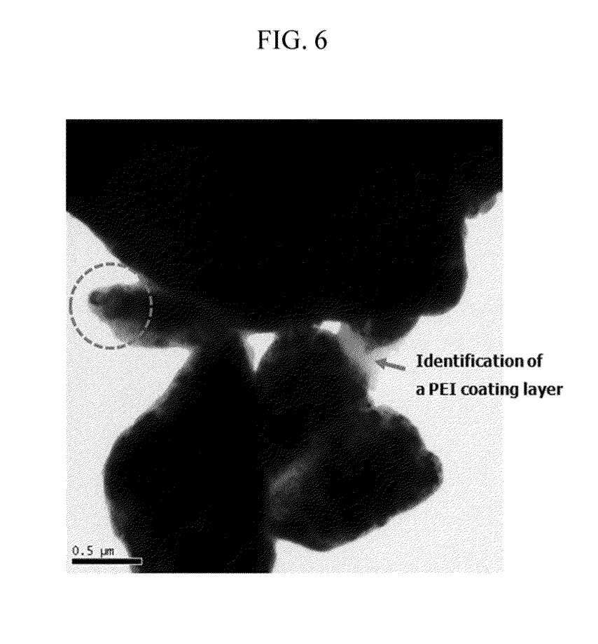

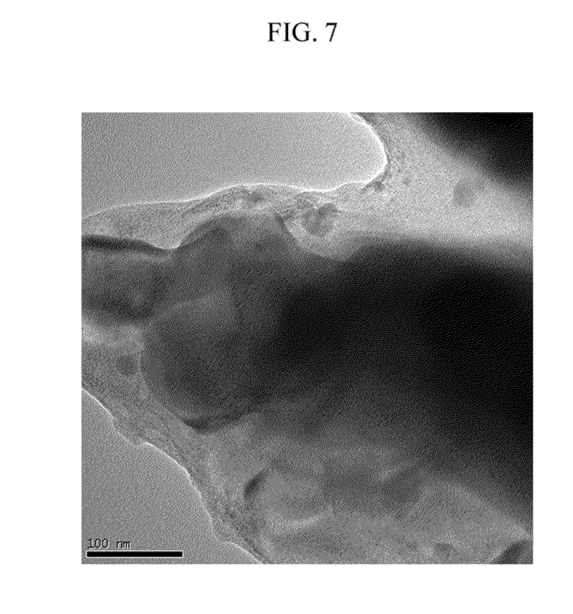

In FIG. 6, an arrow identifies the PEI coating layer, and FIG. 7 illustrates an image of an enlarged view of the region marked with a dotted line in FIG. 6.

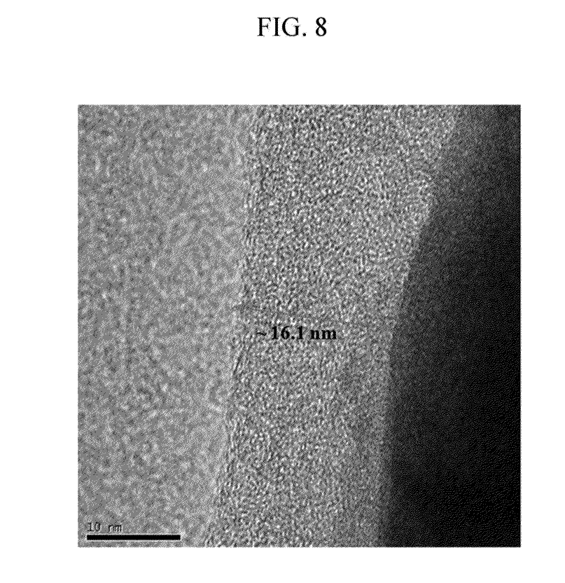

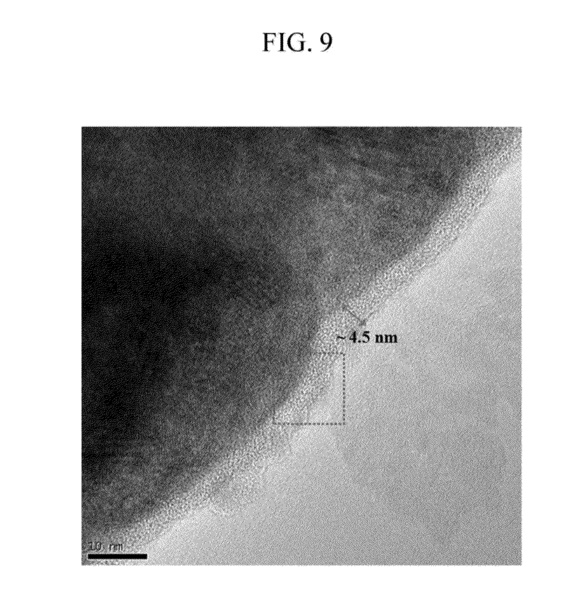

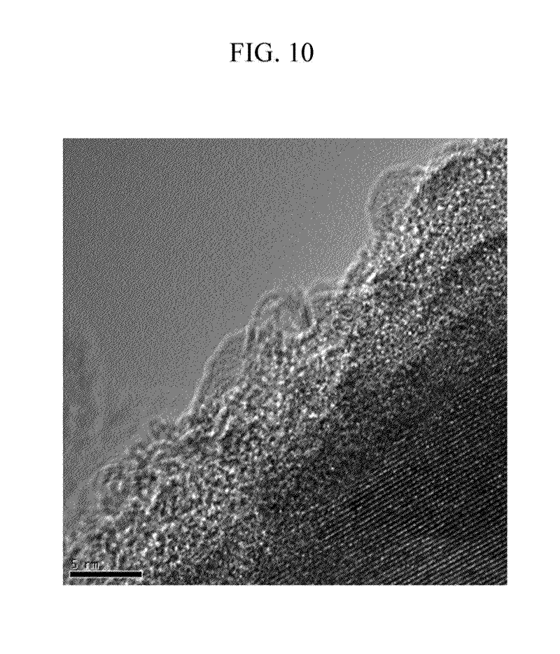

FIGS. 8 and 9 illustrate the organic binder of PEI was coated to be respectively about 16.1 nm and 4.5 nm thick. FIG. 10 illustrates an image of an enlarged view of the region marked with a dotted line in FIG. 9.

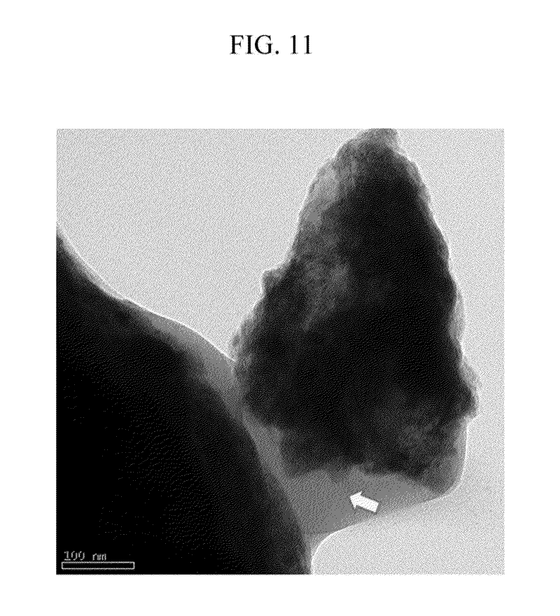

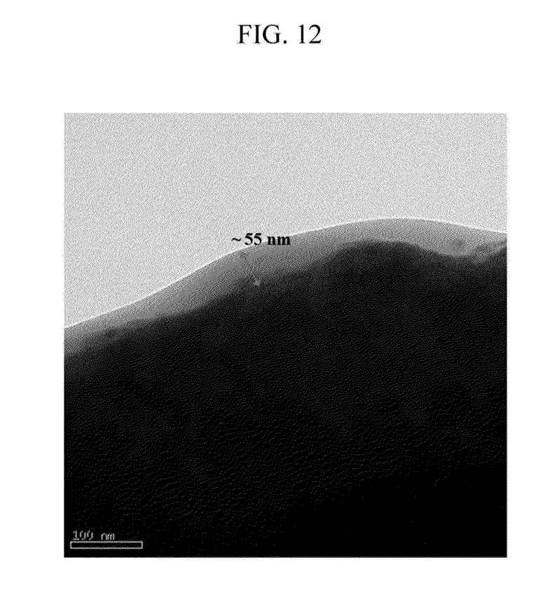

FIG. 11 illustrates a PEI coating layer including powder particles that are entangled in the arrow region, and FIG. 12 illustrates a 55 nm thick PEI coating layer.

### Example 2

### Preparing a Negative Active Material

A SiTiNi powder having an average diameter of 5 μm was prepared using a melt spinning equipment. Next, a PAI (polyamideimide) solution (concentration: 30 wt %, KSC4013, Shin-Etsu Chemical Co., Ltd.) was added to the SiTiNi powder. The mixture was agitated at room temperature for 24 hours, filtered, and vacuum-dried at 120° C. for 6 hours, to prepare a negative active material. The prepared negative active material had a core having an average diameter of about 5 μm and a coating layer having an average thickness of about 50 nm. The SiTiNi and PAI were included in a weight ratio of 95:5. The coating layer was continuous

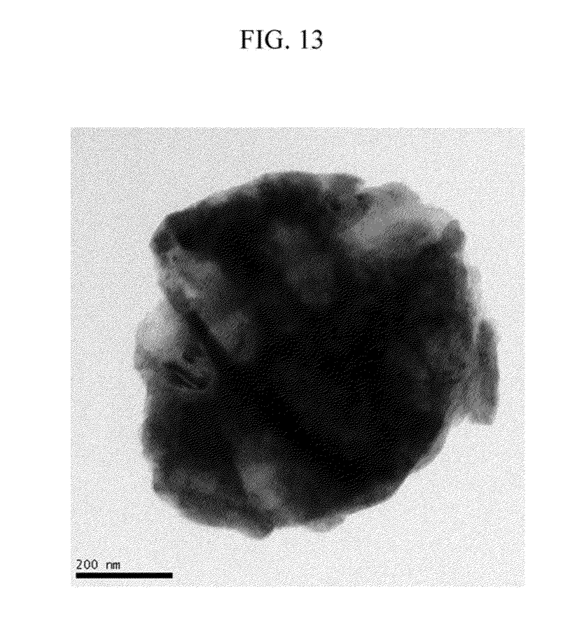

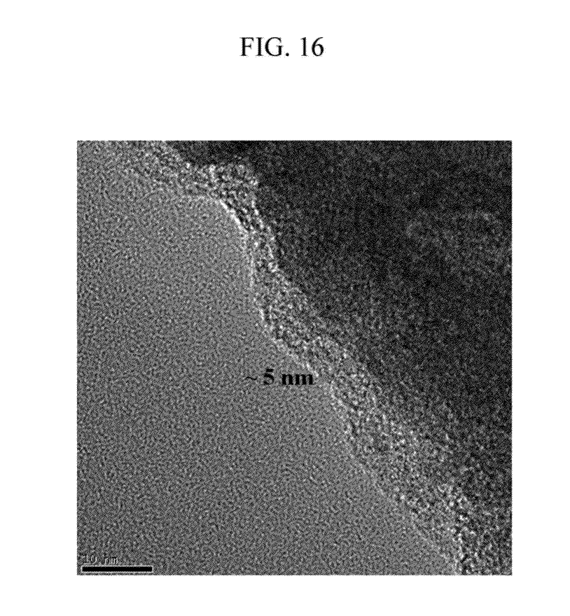

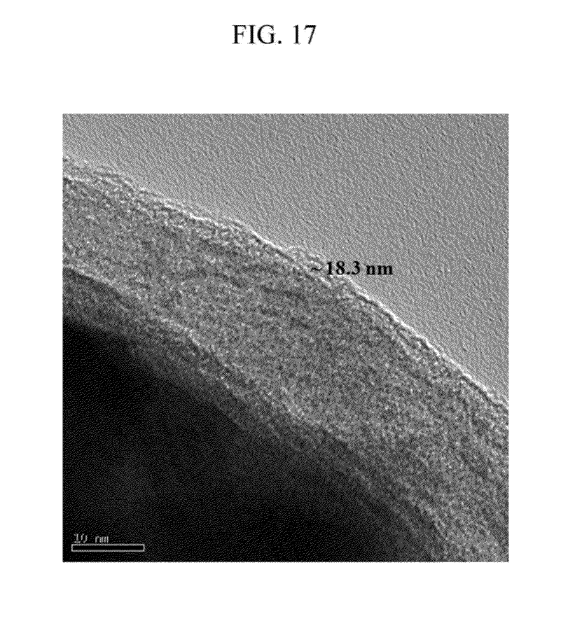

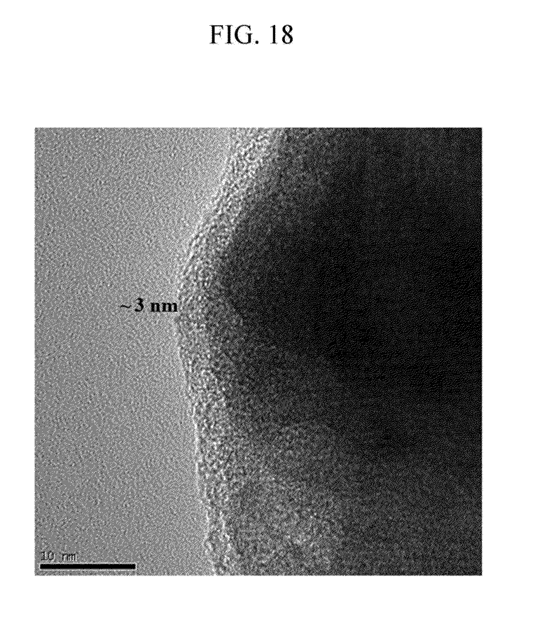

FIGS. 13 to 24 illustrate TEM images of the negative active material particles according to Example 2 to examine the thickness of the coating layers.

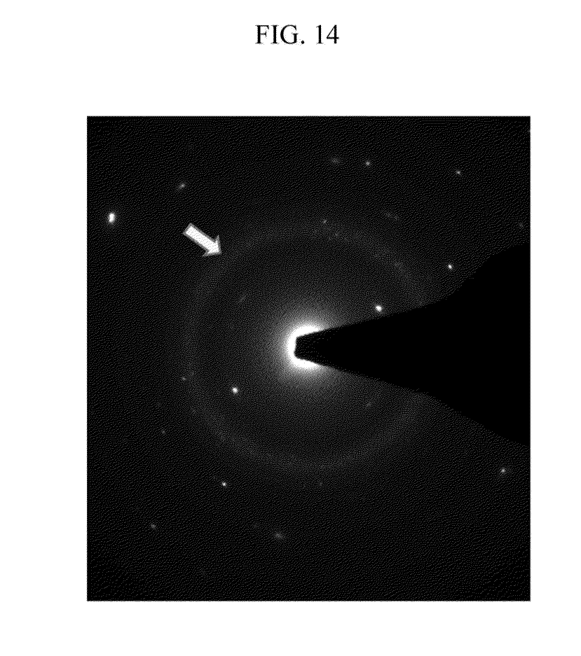

In FIG. 14, the thick ring near the arrow shows that an organic binder PAI was coated on the SiTiNi powder and formed a coating layer thereon.

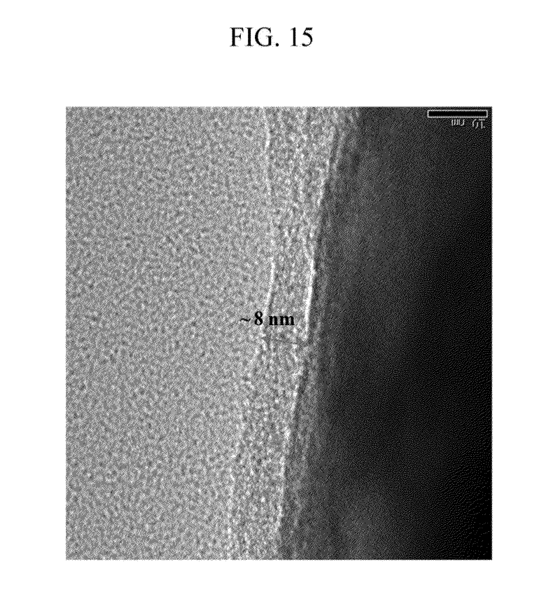

In FIGS. 15 to 18, the organic binder of PAI was coated to respectively form an about 8 nm, 5 nm, 18.3 nm, and 3 nm thick coating layer (i.e., in a thickness range of about 3 to 20 nm).

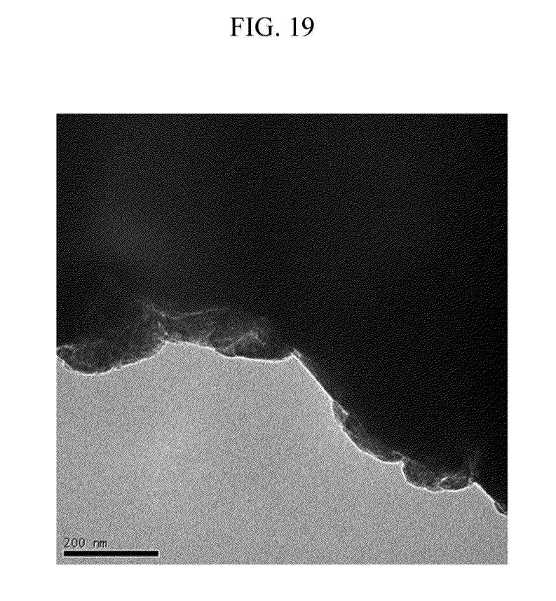

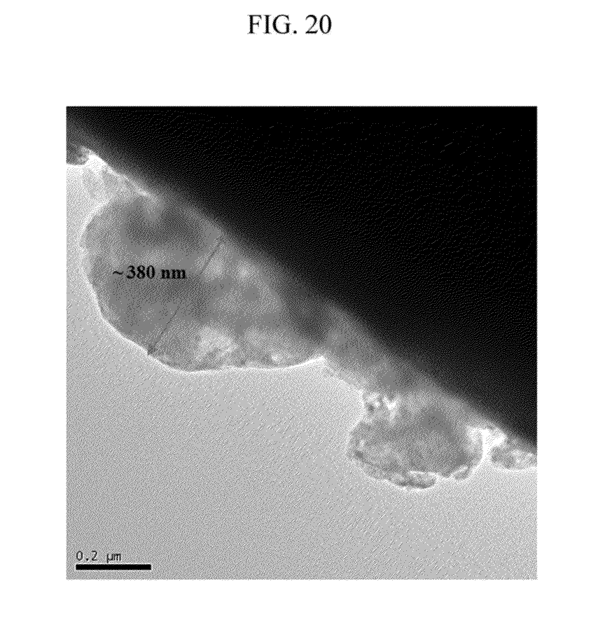

FIG. 19 illustrates that the coating layer was greater than or equal to about 380 nm in a partial region, and FIG. 20 illustrates an image of an enlarged view of the region in FIG. 19.

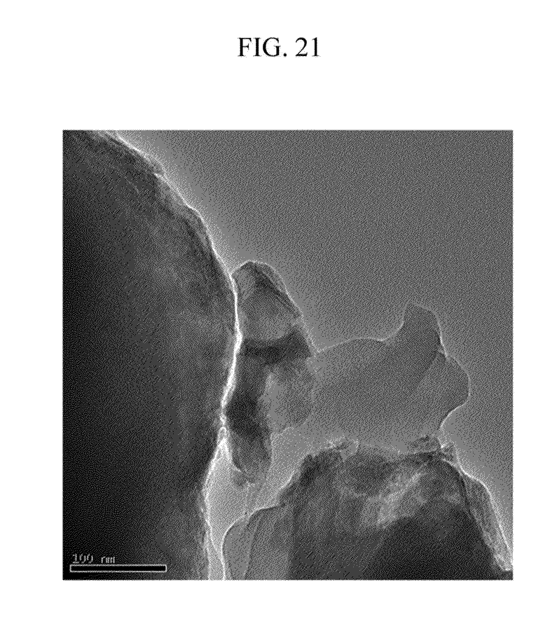

FIG. 21 illustrates the PAI coating layer formed on entangled powder particles.

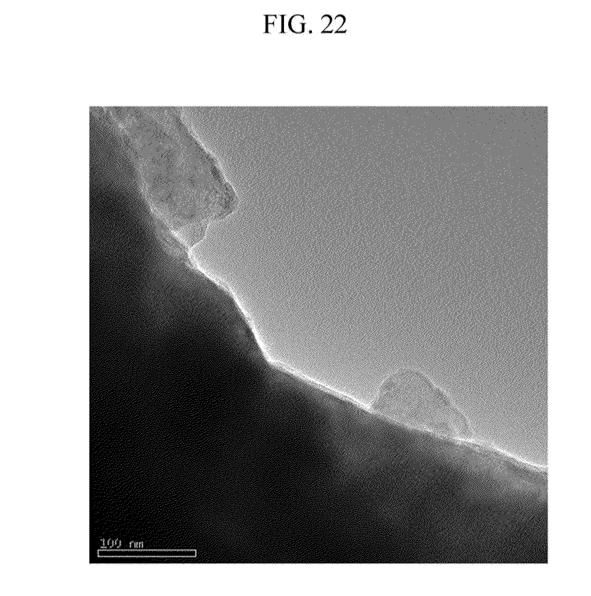

In FIG. 22, a 32.6 nm thick coating layer was formed overall (i.e., continuously), while a 110 nm thick coating layer was partially formed (i.e., discontinuously formed).

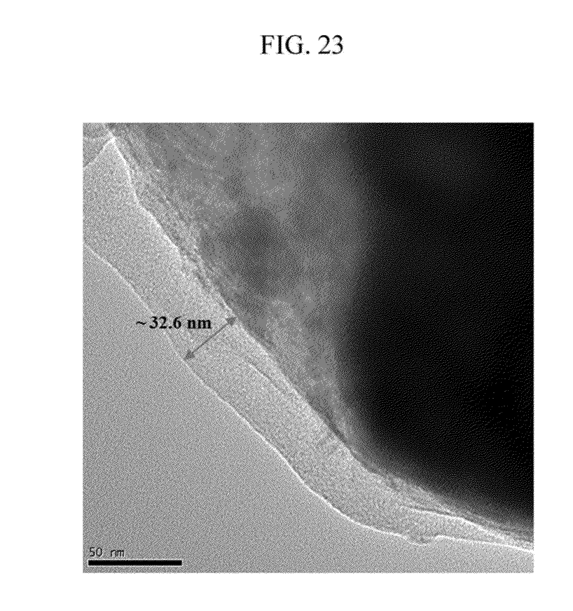

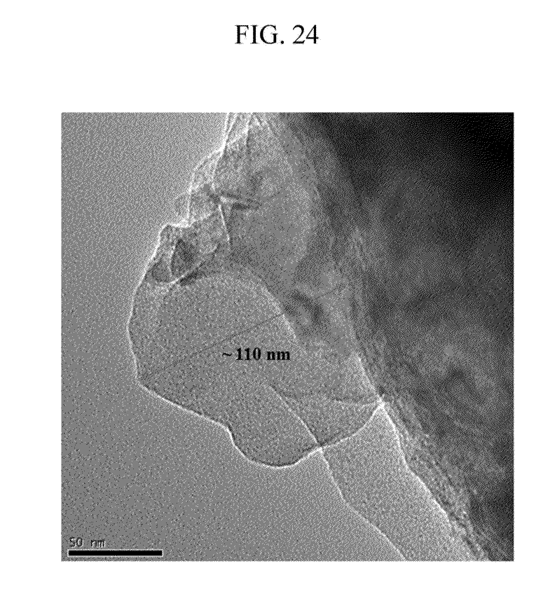

FIGS. 23 and 24 illustrate images of enlarged views of the coating layers illustrated in FIG. 22.

### Comparative Example 1

A SiTiNi powder having an average diameter of 5 μm was prepared using a melt spinning equipment. The obtained SiTiNi powder was used as a negative active material.

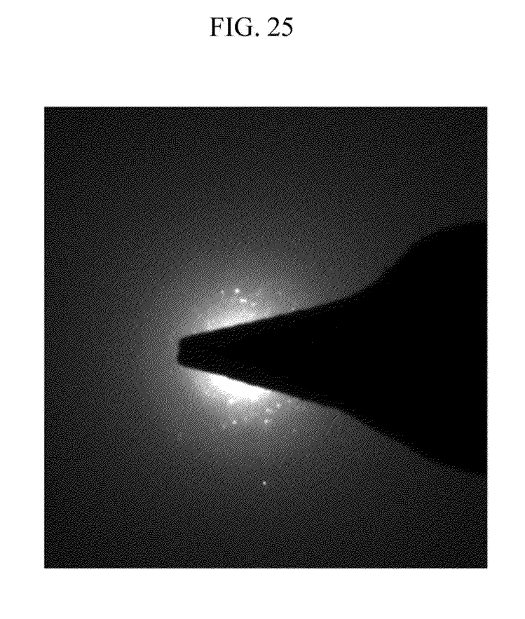

FIG. 25 illustrates a TEM image of the negative active material particle according to Comparative Example 1, and the negative active material particle had no coating layer (unlike the ones shown in FIGS. 3 and 14), as indicated by the absence of the thick ring in FIG. 25.

### Examples 3 to 4

Each negative active material according to Examples 1 and 2, polyamideimide, and ketjen black were mixed in a weight ratio of 88:4:8 in N-methylpyrrolidone, thereby fabricating a negative active material slurry. The slurry was coated to have a predetermined thickness on a copper current collector and dried in an oven, thereby fabricating a negative electrode.

Then, the negative electrode, lithium metal as a counter electrode, an electrolyte solution prepared by mixing EC (ethylenecarbonate)/EMC (ethylmethylcarbonate)/DMC (dimethylcarbonate) in a volume ratio of 3/3/4 and adding 1.5M LiPF₆ to the mixture, were used, thereby fabricating a 2016 coin-type half-cell.

### Comparative Example 2

A 18650 circular cell was fabricated according to the same method as Example 3 except for using the negative active material according to Comparative Example 1.

### Experimental Example 1

### Components of Coating Layer

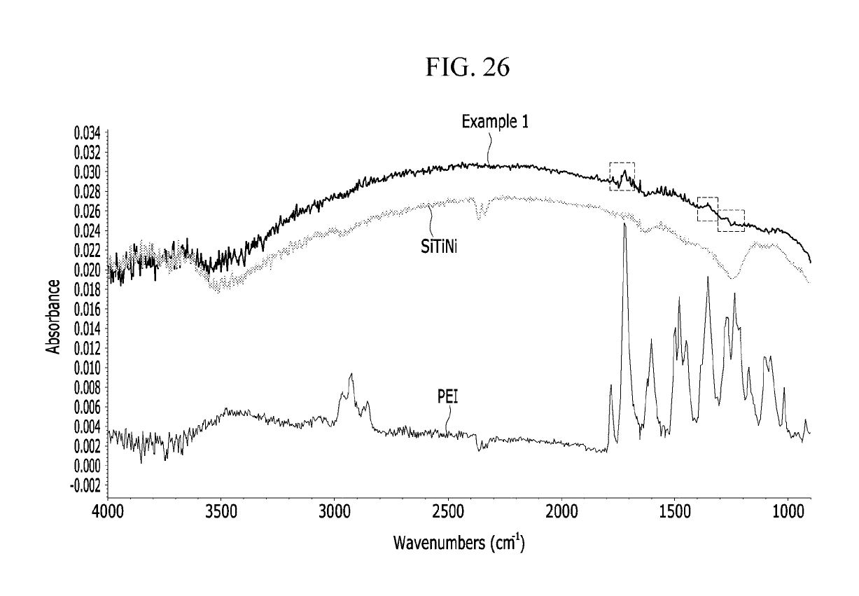

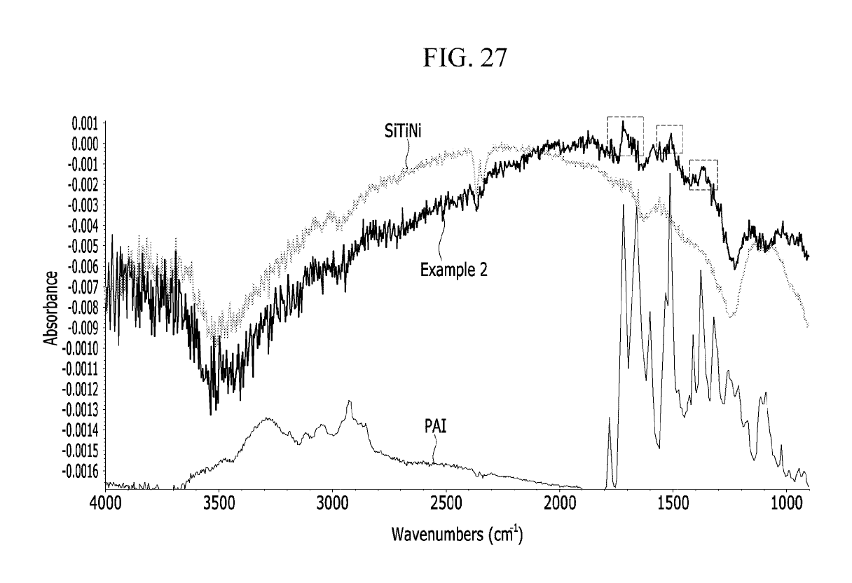

The negative active materials according to Examples 1 and 2 were analyzed regarding ATR-FTIR (Attenuated Total internal Reflectance Fourier Transform Infra-Red spectroscopy, Measurement condition: single bounce, 128-256 scans, resolution 4 cm⁻¹). SiTiNi, PAI, and PEI were respectively analyzed for reference. FIGS. 26 and 27 respectively illustrate the analysis results of the negative active materials according to Examples 1 and 2. In FIGS. 26 and 27, peaks marked with dotted lines indicated components of the coating layer.

### Experimental Example 2

### Cycle-Life Characteristics

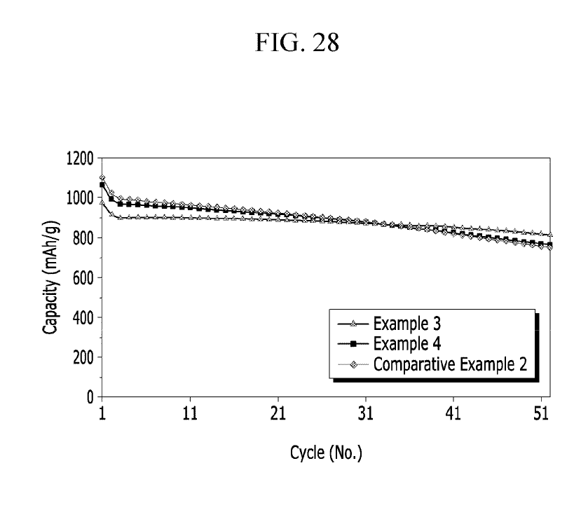

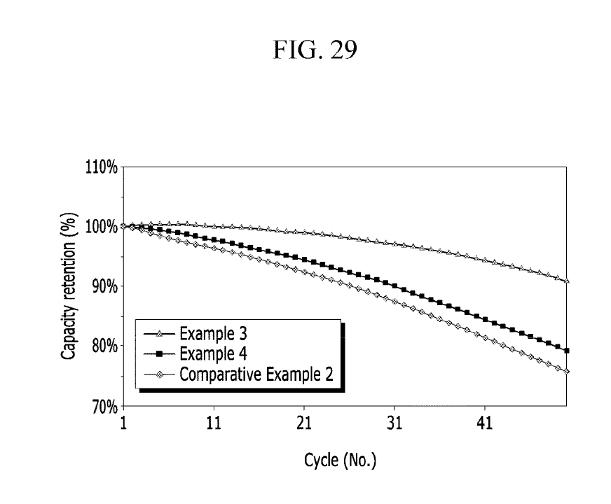

The lithium rechargeable battery cells according to Examples 3 and 4 and Comparative Example 2 were measured regarding cycle-life characteristics. FIGS. 28 and 29 respectively illustrate discharge capacity and capacity retention of the lithium rechargeable battery cells after charging and discharging at 1.0 C for 50 cycles. As illustrated in FIGS. 28 and 29, after the lithium rechargeable battery cells were 50 times charged and discharged, the lithium rechargeable battery cell of Example 3 had discharge capacity of 816 mAh/g and capacity retention of 90.9%, and the one of Example 4 had discharge capacity of 765 mAh/g and capacity retention of 79.2%, while the one of Comparative Example 2 had discharge capacity of 752 mAh/g and capacity retention of 75.8%, (i.e., the discharge capacity and capacity retention of Examples 3 and 4 were improved compared to Comparative Example 2).

By way of summary and review, a lithium rechargeable battery may be used as a power source for a small portable electronic device. It may use an organic electrolyte solution and thus may have a discharge voltage of at least about two times the discharge voltage of a battery using an alkali aqueous solution, and thus may have higher energy density.

A positive active material for a lithium rechargeable battery may be a lithium-transition element composite oxide being capable of intercalating lithium, such as LiCoO₂, LiMn₂O₄, LiNi₁₋ₓCoₓO₂ (0<x<1), and the like. A negative active material for a lithium rechargeable battery may be various carbon-based materials such as artificial graphite, natural graphite, and hard carbon capable of intercalating and deintercalating lithium ions. A non-carbon-based negative active material, such as an Si-based material and the like, may provide improved stability and capacity, however, a silicon alloy-based negative active material may expand in volume when lithium ions react with the silicon-based alloy negative active material during charging, and may shrink in volume when the lithium ions are released during the discharging. In this way, the silicon alloy-based negative active material may have a relatively large volume change during the charge and discharge cycle, and thus may decrease electrical conductivity among the active materials or between the current collector and active material, and may deteriorate cycle-life characteristic of a lithium rechargeable battery. However, the above-mentioned volume change (i.e., expansion) may be substantially reduced through the use of the silicon alloy-based negative active material described above, which may include the coating layer. The coating layer may be formed of the organic binder and may distribute the organic binder over substantially all of the silicon alloy-based negative active material, and thus the silicon alloy-based negative active material may improve cycle-life characteristics of a lithium rechargeable battery. In addition, the silicon alloy-based negative active material may increase the capacity of the lithium rechargeable battery by decreasing the relative amount of the organic binder and increasing the relative amount of the silicon-based alloy material.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A silicon alloy-based negative active material, comprising:
a particle including:
a core including a silicon alloy-based material; and
a coating layer including an organic binder.

2. The silicon alloy-based negative active material as claimed in claim 1, wherein the organic binder includes polyimide, polyamide, polyamideimide, aramid, polyarylate, polymethylethylketone, polyetherimide, polyethersulfone, polysulfone, polyphenylene sulfide, polytetrafluoroethylene, or a combination thereof.

3. The silicon alloy-based negative active material as claimed in claim 1, wherein the organic binder is included in an amount of about 1 wt % to about 10 wt % based on 100 wt % of the silicon alloy-based negative active material.

4. The silicon alloy-based negative active material as claimed in claim 1, wherein the silicon alloy-based material is an alloy represented by Si-Q, wherein Q is not Si and is an alkali metal, an alkaline-earth metal, a group 13 to 16 elements, a transition element, a rare earth element, or a combination thereof.

5. The silicon alloy-based negative active material as claimed in claim 4, wherein the silicon alloy-based material is SiTiNi, SiAlMn, SiAlFe, SiFeCu, SiCuMn, SiMgAl, SiMgCu, or a combination thereof.

6. The silicon alloy-based negative active material as claimed in claim 4, wherein the organic binder includes polyamideimide, polyetherimide, or a combination thereof.

7. The silicon alloy-based negative active material as claimed in claim 1, wherein the silicon alloy-based material is included in an amount of about 50 wt % to about 99 wt % based on 100 wt % of the silicon alloy-based negative active material.

8. The silicon alloy-based negative active material as claimed in claim 1, wherein the coating layer has an average thickness of about 1 nm to about 300 nm.

9. The silicon alloy-based negative active material as claimed in claim 8, wherein the coating layer has a first portion with a thickness of about 1 nm to about 35 nm.

10. The silicon alloy-based negative active material as claimed in claim 9, wherein the coating layer has a second portion with a thickness of about 100 nm to about 300 nm.

11. The silicon alloy-based negative active material as claimed in claim 1, wherein the coating layer is continuous.

12. The silicon alloy-based negative active material as claimed in claim 1, wherein the coating layer is discontinuous.

13. The silicon alloy-based negative active material as claimed in claim 1, wherein the core has an average diameter ranging from about 0.1 μm to about 10 μm.

14. A negative active material composition, comprising:
the silicon alloy-based negative active material as claimed in claim 1; and
a binder.

15. A method of manufacturing a negative active material composition, comprising:
preparing a silicon alloy-based material, and
coating an organic binder on a surface of the silicon alloy-based material to form a coated silicon alloy-based negative active material.

16. The method as claimed in claim 15, further comprising mixing the coated silicon alloy-based negative active material and a binder.

17. The method as claimed in claim 15, wherein the coating of the organic binder includes drying at about 100° C. to about 120° C.

18. The method as claimed in claim 15, wherein the coating of the organic binder includes heat treatment at about 300° C. to about 400° C.

19. The method as claimed in claim 15, wherein:
the organic binder includes polyamideimide, polyetherimide, or a combination thereof, and
the silicon alloy-based material is SiTiNi.

20. A lithium rechargeable battery, comprising:
a negative electrode including the silicon alloy-based negative active material as claimed in claim 1;
a positive electrode including a positive active material; and
a non-aqueous electrolyte.
